(19) United States
(12) Patent Application Publication
(10) Pub. No.: US 2026/0052520 A1
(43) Pub. Date: Feb. 19, 2026

(54) AI-ASSISTED MOBILE NETWORK RESOURCE SELECTION FOR HIGHLY AVAILABLE PUBLIC SAFETY NETWORKS

(71) Applicants: AT&T Intellectual Property I, L.P., Atlanta, GA (US); AT&T Mobility II LLC, Atlanta, GA (US)

(72) Inventors: Richard T. Kwapniewski, Middletown, NJ (US); Prashant Raghuvanshi, Parker, CO (US)

(73) Assignees: AT&T Intellectual Property I, L.P., Atlanta, GA (US); AT&T Mobility II LLC, Atlanta, GA (US)

(21) Appl. No.: 18/805,946

(22) Filed: Aug. 15, 2024

(51) Int. Cl. H04W 72/0453; H04W 24/08

(52) U.S. Cl. CPC H04W 72/0453; H04W 24/08

(57) ABSTRACT

Aspects of the subject disclosure may include, for example, selecting a frequency band for user equipment in a mobile network based on a service to be accessed by the user equipment, selecting an infrastructure core network from a plurality of available infrastructure core networks, selecting a service core network from among a plurality of available service core networks. Artificial intelligence or machine learning may assist in all selections. Other embodiments are disclosed.

### FIELD OF THE DISCLOSURE

The subject disclosure relates to a system and method using artificial intelligence (AI) to assist in selection of resources in mobile communication networks, particularly for public safety networks that must have high service availability.

### BACKGROUND

Mobile communication networks provide radio communication services to a wide variety of users. The users, in turn, have a wide range of applications for the communication services they access. The operator of the mobile network needs to retain substantial flexibility in configuring different portions of the mobile communication network.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a process for radio frequency band selection in the system of FIG. 2A.

FIG. 2C depicts an illustrative embodiment of a method for radio frequency band assignment in the system of FIG. 2A.

FIG. 2D is a block diagram illustrating an example, non-limiting embodiment of a system functioning within the communication network of FIG. 1 in accordance with various aspects described herein.

FIG. 2E is a block diagram illustrating an example, non-limiting embodiment of a global orchestrator functioning within the system of FIG. 2A in accordance with various aspects described herein.

FIG. 2F is a block diagram illustrating an example, non-limiting embodiment of a portion of the system shown in FIG. 2D in accordance with various aspects described herein.

FIG. 2G depicts an illustrative embodiment of a method for provisioning an infrastructure core network in the system of FIG. 2D.

FIG. 2H depicts an illustrative embodiment of a backup and disaster recovery system in accordance with various aspects described herein.

FIG. 2I depicts an illustrative embodiment of a load balancing system in accordance with various aspects described herein.

FIG. 2J is a block diagram illustrating an example, non-limiting embodiment of a portion of the system shown in FIG. 2D in accordance with various aspects described herein.

FIG. 2K depicts an illustrative embodiment of a method for provisioning a backup and disaster recovery network in the system of FIG. 2H.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for selecting a frequency band for user equipment in a mobile network based on a service to be accessed by the user equipment, selecting an infrastructure core network from a plurality of available infrastructure core networks, selecting a service core network from among a plurality of available service core networks. Artificial intelligence or machine learning may assist in all selections. Other embodiments are described in the subject disclosure.

One or more aspects of the subject disclosure include attaching a user equipment (UE) to a radio access network at an access frequency, receiving, from the UE, a request to access a selected service through the radio access network, and assigning the UE to a selected frequency band for accessing the service, wherein the selected frequency band for accessing the service is selected based on the service.

One or more aspects of the subject disclosure include attaching a user equipment (UE) to a radio access network, receiving capability information about a plurality of available infrastructure core networks accessible to the radio access network, selecting, based on the capability information, a selected infrastructure network, determining provisioning information for the selected infrastructure network, reattaching the UE to the radio access network, and attaching the UE to the selected infrastructure network based on the provisioning information for the selected infrastructure network.

One or more aspects of the subject disclosure include attaching a user equipment (UE) to a radio access network, receiving capability information about a plurality of available service core networks accessible to the radio access network through an infrastructure core network, the plurality of available service core networks providing network services of interest, selecting a selected service network, wherein the selecting is based on the capability information, attaching the UE to the selected service network, wherein the selecting is based on the capability information for the selected service network, and initiating communication between the UE and the selected service network, including providing network services from the selected service network to the UE.

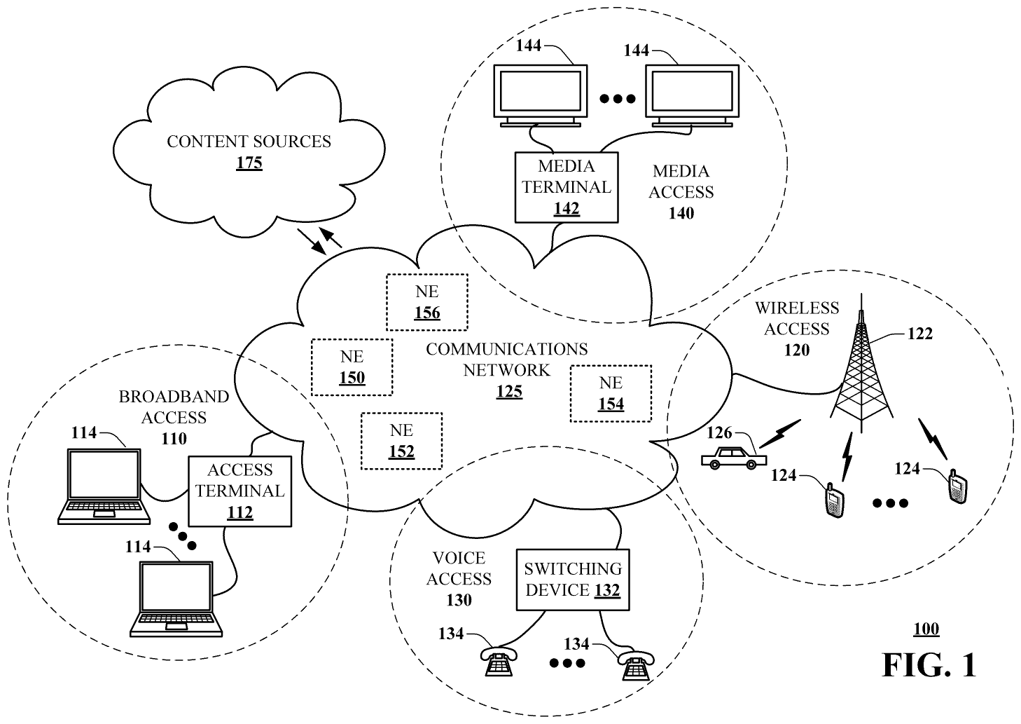

Referring now to FIG. 1, a block diagram is shown illustrating an example, non-limiting embodiment of a system 100 in accordance with various aspects described herein. For example, system 100 can facilitate in whole or in part selecting a frequency band for user equipment in a mobile network based on a service to be accessed by the user equipment, selecting an infrastructure core network from a plurality of available infrastructure core networks, selecting a service core network from among a plurality of available service core networks. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VOIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VOIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

For a mobile network such as the wireless access 120, there are multiple components of the mobile network which together provide end-to-end service to a mobile user such as mobile devices 124 and vehicle 126. Components of the mobile network include, first, an Access Network, including specific radio frequencies, which provides radio communication between network infrastructure such as base station or access point 122 and a mobile user. Second, the mobile network includes an Infrastructure Core Network, which enables functions such as authentication, authorization, location tracking, policy enforcement, billing, session control and subscriber management, Third, a mobile network includes a Service Network which provides subscriber access to particular services and applications.

At each of these components, multiple resources may be available and a specific selection may need to be made for a particular user or application. The selection should optimizing the end-to-end flow for performance, cost, features, etc., or for providing high availability, esp. for public safety use cases. An individual user generally does not possess the necessary information about the user's application behavior or network characteristics, or have the technical know-how, in order to make such selections to obtain the desired optimization.

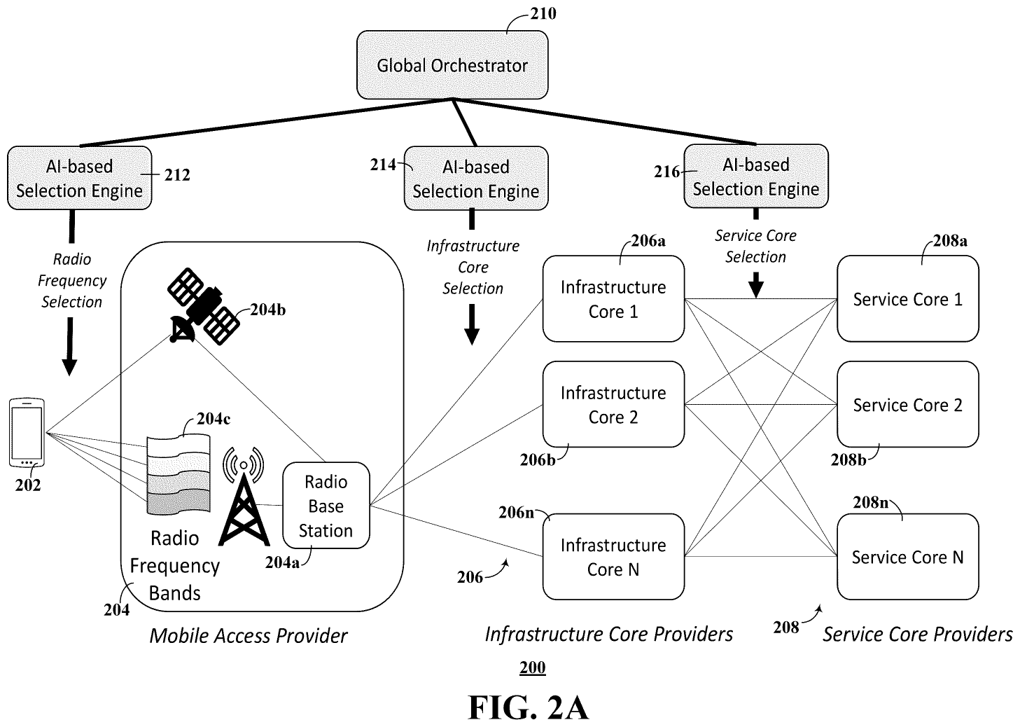

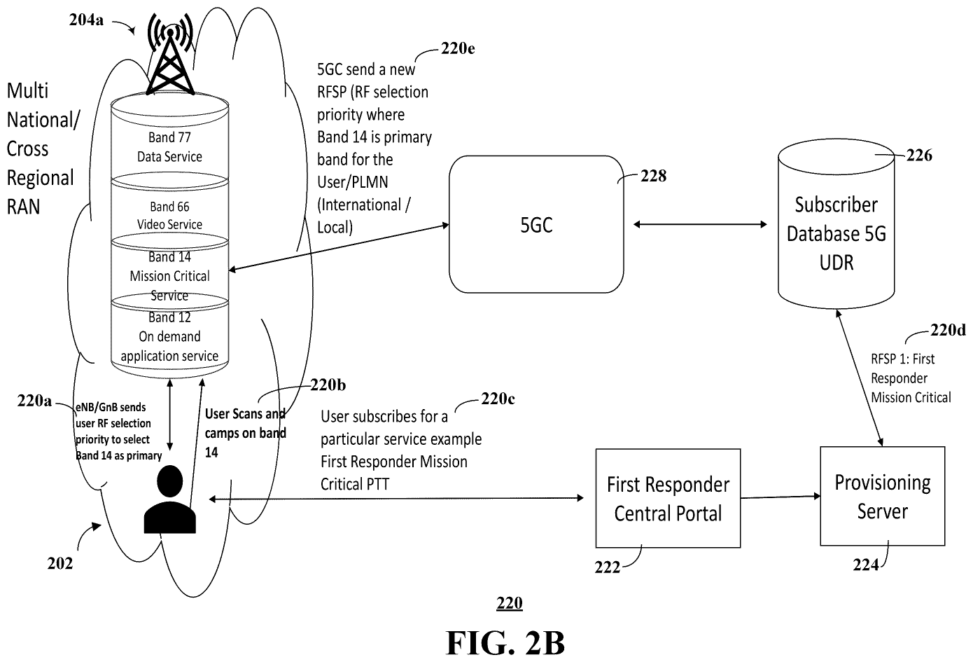

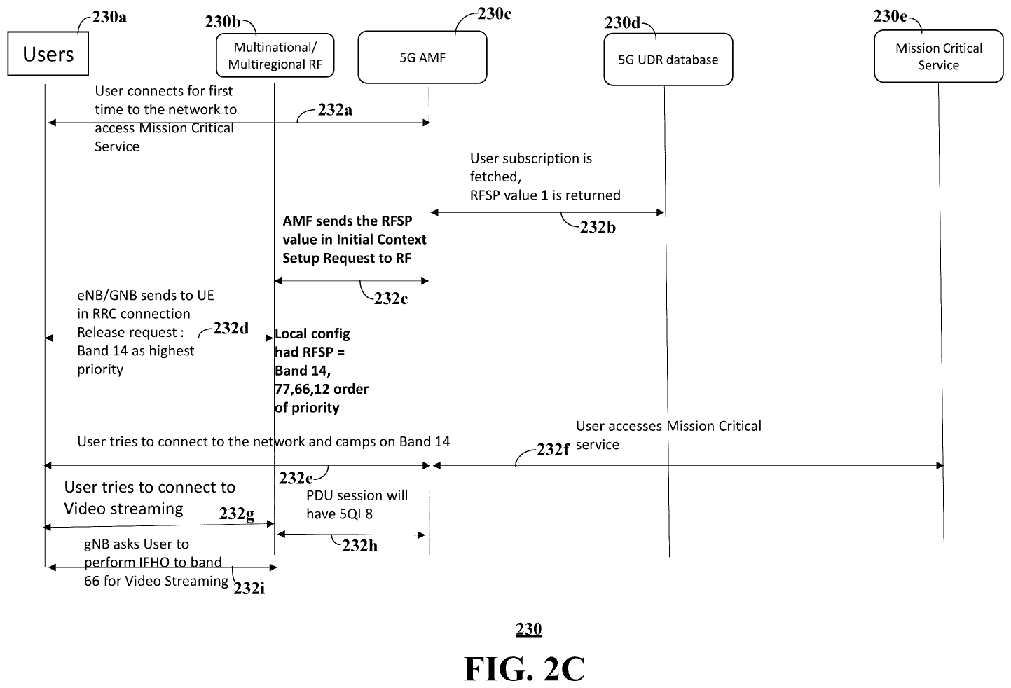

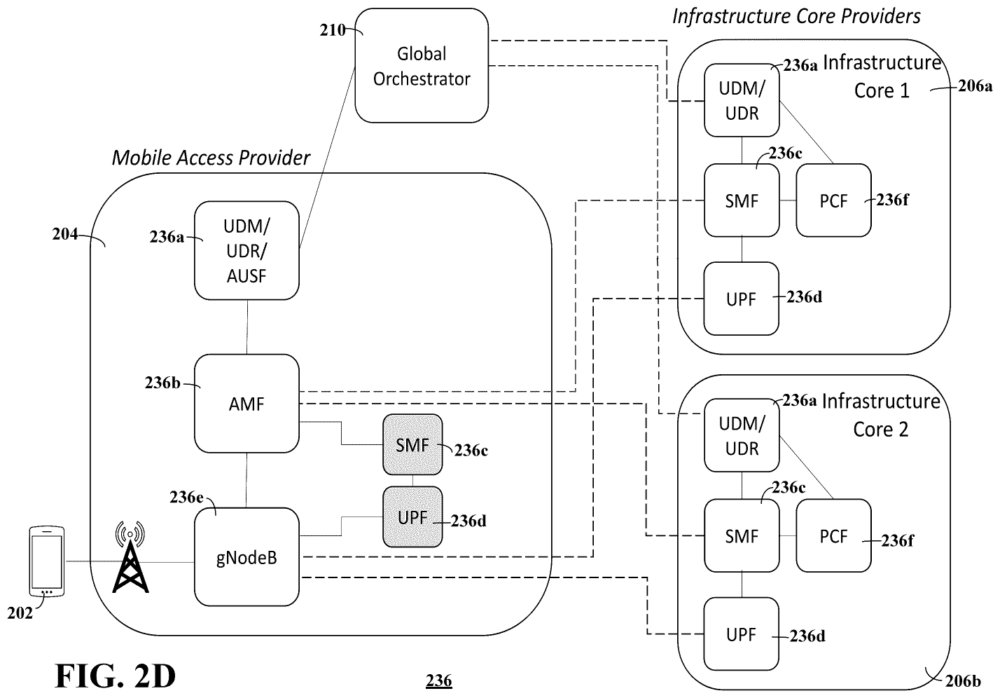

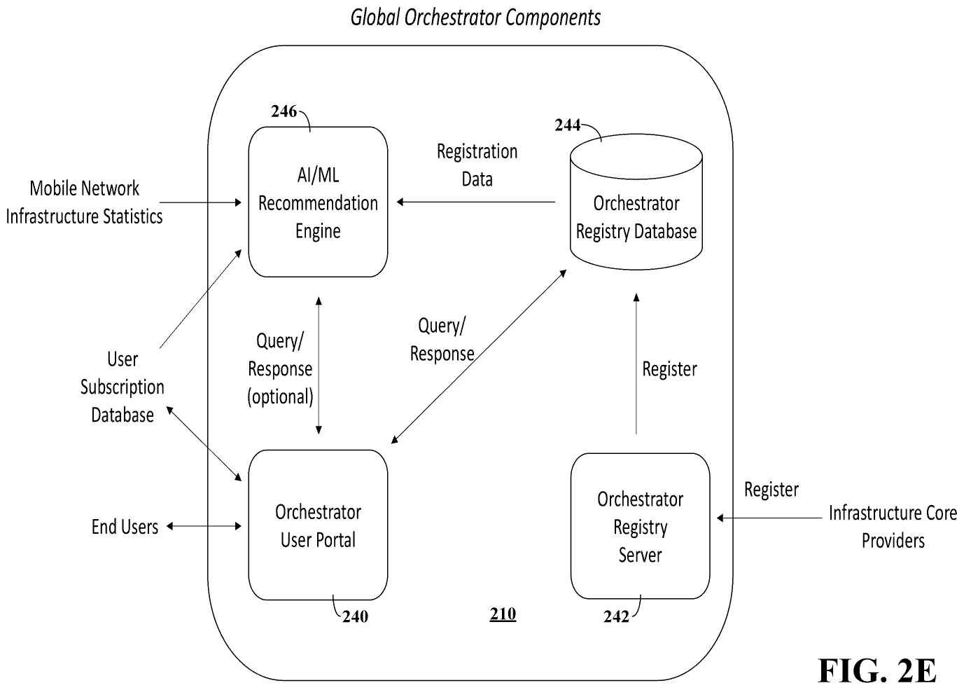

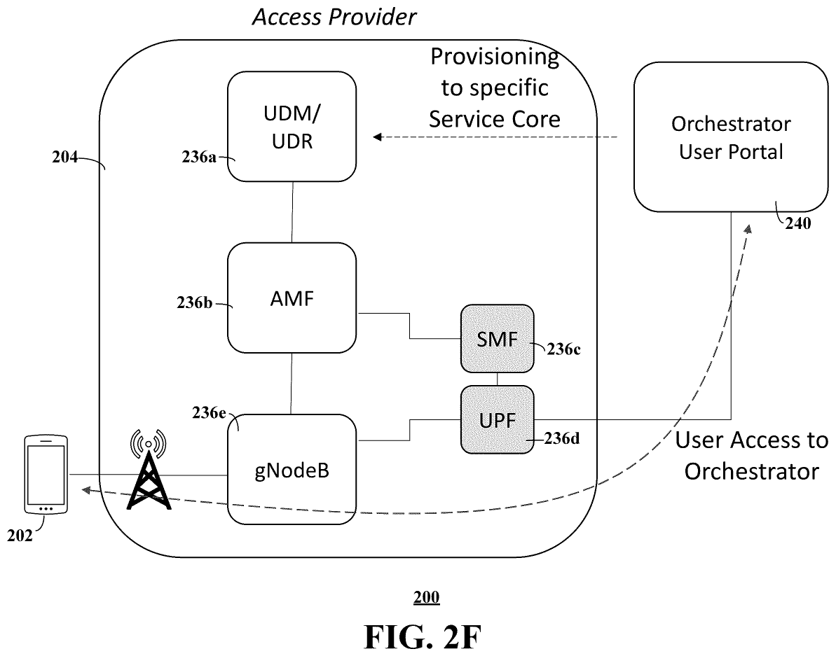

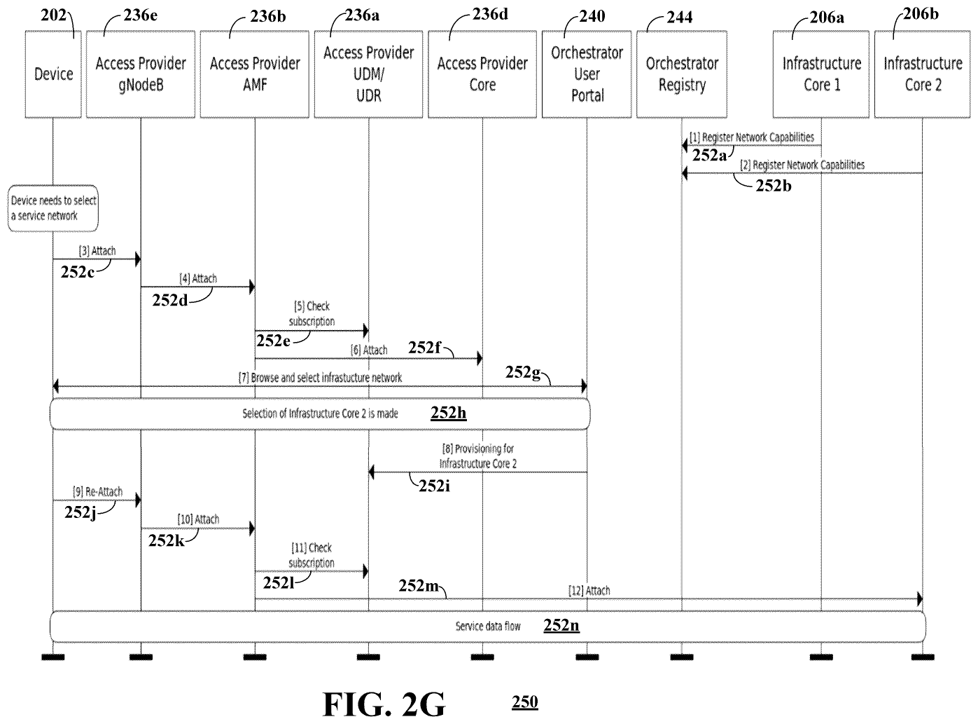

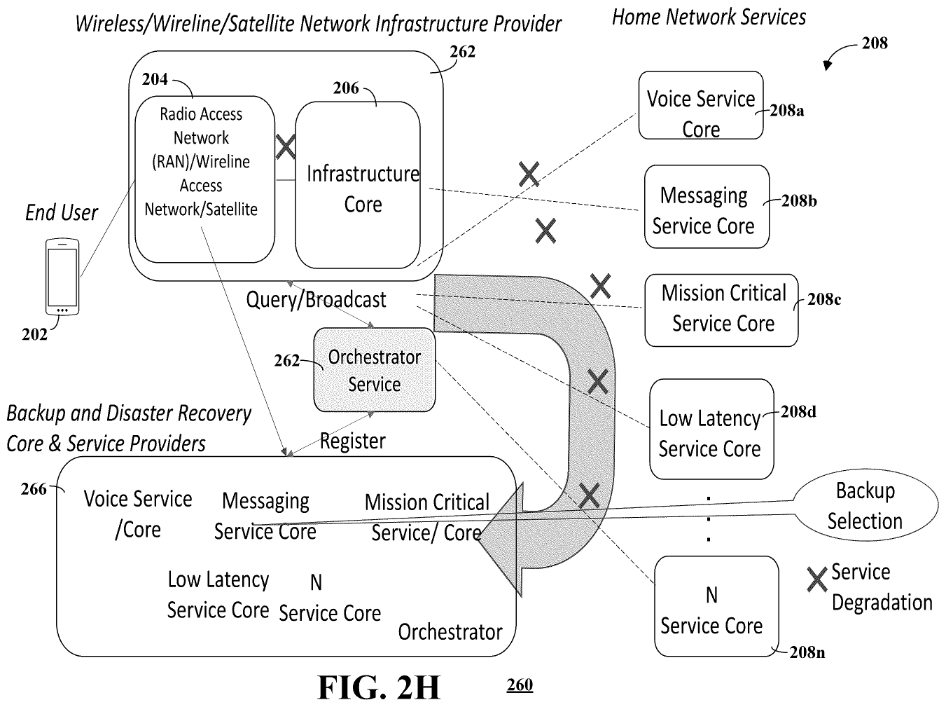

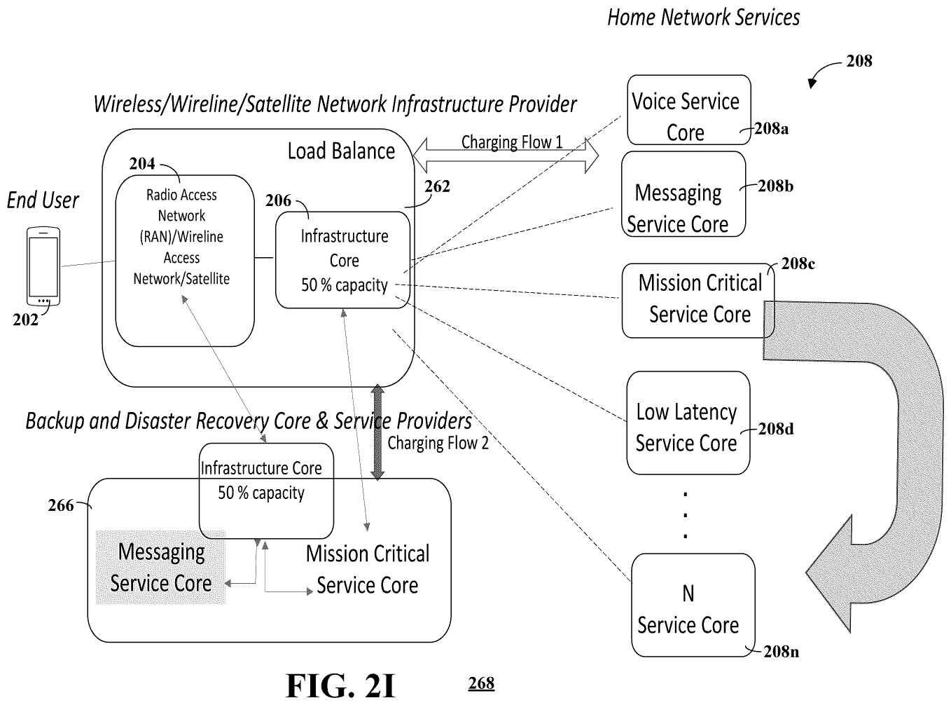

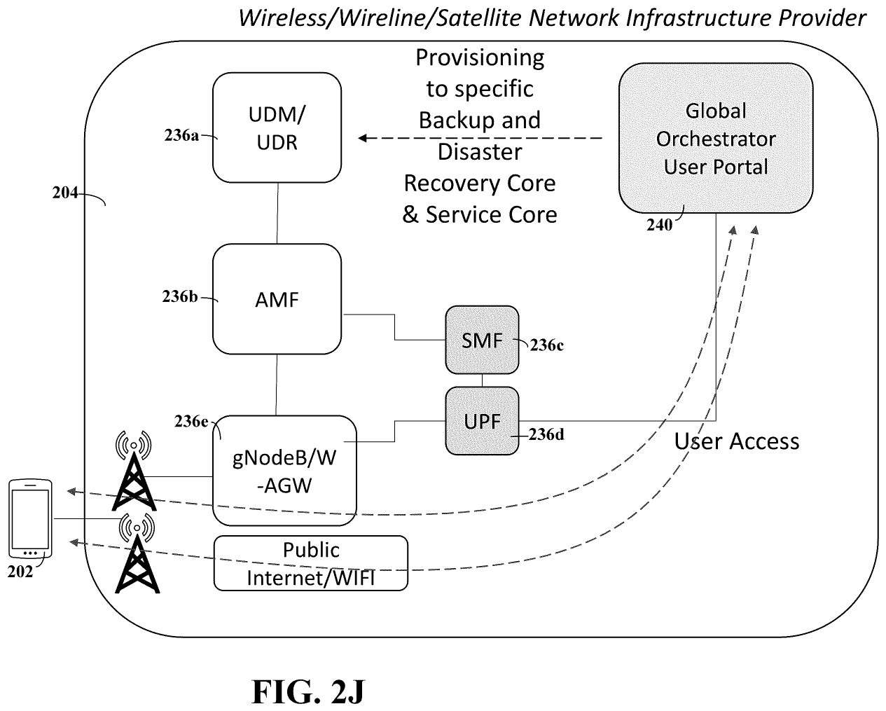

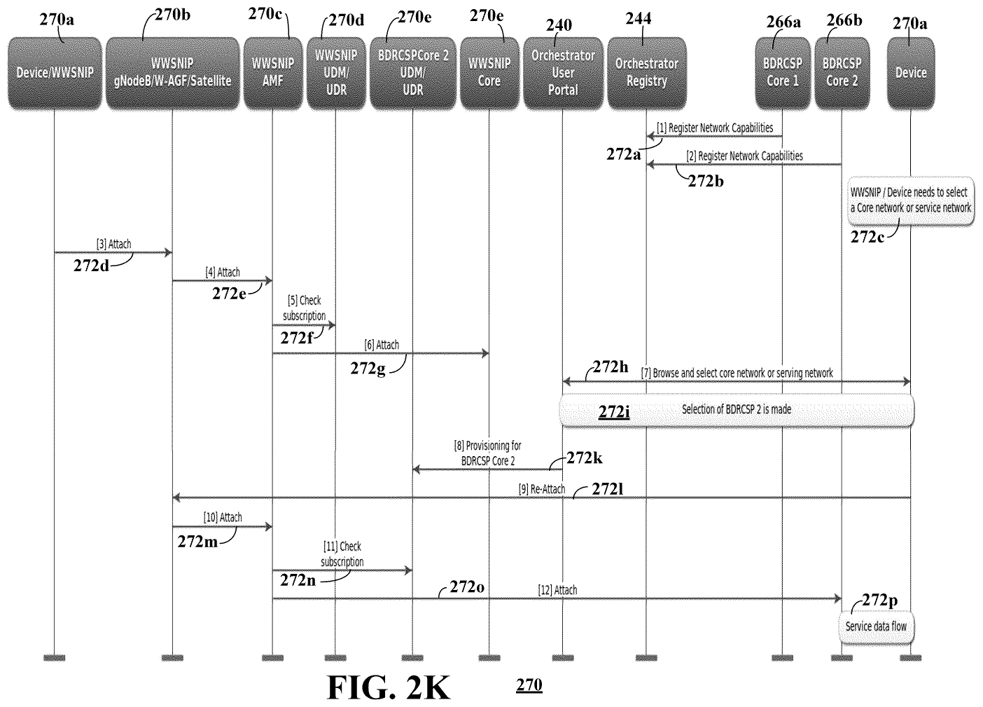

FIG. 2A is a block diagram illustrating an example, non-limiting embodiment of a system 200 functioning within the communications network 125 of FIG. 1 in accordance with various aspects described herein. The system 200 implements a mobile communications network for providing communications services to user equipment (UE) such as UE 202. The system 200 in the illustrated embodiment includes a mobile access provider 204, infrastructure core providers 206, and service core providers 208. For analysis and selection of resources for the UE 202, the system 200 further includes a global orchestrator 210, an AI-based radio frequency selection engine 212, an AI-based infrastructure core selection engine 214 and an AI-based service core selection engine 216.

The mobile access provider 204 operates a mobile communication network including, in the exemplary embodiment, a plurality of base stations such as base station 204a and a plurality of earth-orbiting satellites such as satellite 204b. The plurality of base stations and the plurality of satellites are selectively in radio communication with UEs including the UE 202. The UEs may include mobile telephones, internet of things (IoT) devices and other devices. The UEs, the plurality of satellites and the plurality of base stations communicate together according to a published air interface standard such as the fourth generation (4G or LTE) cellular standard, the fifth generation (5G) cellular standard, the sixth generation (6G) cellular standard, and any follow-on or similar standards that may be developed.

Communication among the UEs, the plurality of satellites and the plurality of base stations is performed using bands of radio frequencies such as frequency bands 204c. The mobile access provider 204 may license the frequency bands 204c from a government or other authority. The frequencies of the frequency bands 204c may be continuous or discontinuous across the licensed spectrum. In general, when a UE such as UE 202 or a base station such as base station 204a initiate radio communication, one or more frequency bands 204c is assigned or selected for the purpose of communication. Communication frequencies may be reassigned by the mobile communications system as required.

The infrastructure core providers 206 each provide one or more infrastructure cores such as the core of the first infrastructure core provider 206a, infrastructure core 206b and infrastructure core 206n. As indicated, any number of infrastructure cores may be available for selection to serve a UE such as UE 202. For example, conventionally, a region is served by a set number of mobile network operators (MNOs). Each MNO operates a mobile access network and one or more infrastructure core networks. The mobile access network and the infrastructure core networks provide services to UEs who are subscribers to those services under terms of a subscription agreement. The UE devices operate in internet protocol sessions that get terminated on elements of an infrastructure core network. Each infrastructure core network of an MNO may have a specific purpose and provide specific services. In one example, the components of a first infrastructure core network are routinely used to service UEs and the components of a second infrastructure core network are available as spares in the event of an outage in all or part of the first infrastructure core network. In another example, different infrastructure core networks serve different geographic regions of a service area.

In accordance with various aspects described herein, the respective MNOs may elect to offer access to UEs who are not subscribers to the MNO's mobile access network. In effect, there may be competition among infrastructure core network operators, some of whom do not operate radio access networks. However, each infrastructure core network may offer unique services or pricing or other features of interest to potential customers. The system 200 operates to connect a UE such as UE 202 with a mobile access provider 204 and with a selected infrastructure core network of one of the infrastructure core providers 206.

Similarly, multiple MNOs may elect to offer access to their service core networks. In the example of FIG. 2A, the service core providers 208 provide a number of selectable service core networks, including selectable service core network 208a, selectable service core network 208b and selectable service core network 208n. The service core providers 208 may include one or more MNO. Plus, in some examples, the service core providers 208 may include additional providers in adjacent markets, such as cloud computing or building, deploying, and managing websites, applications or processes for a variety of customers. The user of the UE 202 or other device may access one or more particular service core networks of the service core providers 208 for a particular function, purpose or application. Examples include accessing the public internet, accessing a video streaming service, or accessing a mission critical push-to-talk function as is used by, for example, first responders such as police and fire personnel. The service core providers 208 may thus compete for customers among the UE owners and among the infrastructure core providers 206. The system 200 operates to connect a UE such as UE 202 with a mobile access provider 204 and with a selected service core provider of one of the service core providers, by means of a selected infrastructure core network of one of the infrastructure core providers 206.

The global orchestrator 210, the selection engine 212, the selection engine 214 and the selection engine 216 operate to connect a UE such as the UE 202 with one or more infrastructure core networks and one or more service core networks. In accordance with various aspects described herein, artificial intelligence (AI) features may be introduced at various decision points in the network components in order to make the right selection decision for the specific use case. An AI model is trained based on various network inputs to allow it to perform real-time analysis and a predictive decision on the optimal resource to be selected. In the illustrated example, the AI prediction tool may be termed the global orchestrator 210. The global orchestrator 210 has interfaces to network components at the various decision points. In embodiments, three specific resource selection points are identified. These include radio frequency selection, infrastructure core selection, and service core selection.

### A. Radio Frequency Selection

FIG. 2B depicts an illustrative embodiment of a process 220 for radio frequency band selection in the system of FIG. 2A.

Conventionally, when a particular 5G or 4G device, such as a UE or IoT device, connects to the RF network, it scans the RF frequency based on a default priority of band order already defined on the device. For example, if the UE is dedicated to first responder usage, it is preconfigured to prefer to connect on Band 14 or band n77, which are radio frequency bands dedicated to such purposes. In other cases, the UE scans available frequencies or uses a frequency band assigned by the network to attach to the network.

Once the UE connects to the network, the 5G Core or LTE network can use a network parameter referred to as radio access technology (RAT) frequency selection priority index, abbreviated RFSP or RFSP index, to send a particular RF priority for connecting going forward. Once the UE goes to idle and is not in a session, the RFSP may be used to set the preferred frequency band to be used by the UE when the UE exits the idle mode and reconnects to the network. The RFSP index is a parameter used by mobile networks to control how mobile devices select and reselect cells. In some applications, it may be useful for steering mobile traffic onto the mobile network operator's preferred RAT and frequency bands. A higher RFSP value indicates a higher priority for that particular RAT and frequency combination. In examples, the network may assign a higher RFSP index to an LTE layer at a base station which has both LTE and 5G capabilities. Such an assignment would encourage UE devices to prefer LTE over 5G. In another example, the network may prioritize one frequency band over another in order to balance traffic load across the network.

In an exemplary embodiment, a simple mechanism is provided to tie a RFSP priority to a particular service or region or nation. More particularly, a particular service may be tied to a particular frequency band. One example of such a service is mission critical services used by emergency personnel or first responders. In this example, a 700 MHz frequency band referred to as Band 14 is specifically designated for public safety agencies and other first responder users. In the example, if the UE is being used for non-mission critical purposes, the UE operates conventionally on appropriate or assigned frequency bands. One example is the frequency band referred to as n77, which is referred to as C-band 5G and operates in a range of 3.3 to 4.0 GHz. The n77 band generally has substantial capacity and bandwidth available for services such as data browsing by a UE or downloading a video file to the UE.

However, if the user opens an application on the UE related to mission critical services, or initiates a communication session on an uplink related to mission critical services, or receives a downlink communication from a source associated with mission critical services such as a county disaster preparedness organization, the UE would then prefer to communicate on Band 14. This will be the case irrespective of the default priority that was established for the UE otherwise. Band 14 is dedicated for public safety purposes and may not be as subject to congestion as a non-dedicated band such as n77. This preference may be established by the RFSP index communicated to the UE by the network.

Further, assignment of a UE to Band 14 may alter the relative priority given to that UE. For example, a parameter call quality of service (QOS) controls performance, reliability and usability of a telecommunications service. In 5G, the parameter may be termed 5QI. Different services are given different priorities using the QoS designation. Services such as streaming media, voice of internet protocol (VOIP) and mission critical services may be given a specific priority based on the QoS designation. In this manner, a mission critical user may preempt general public users accessing the same base station or cell in the mobile network. The first responder who is accessing a mission critical application may get priority over a non-priority user who is performing a bulk file transfer using transmission control protocol (TCP), for example.

Further, in accordance with some embodiments, access to different frequencies or frequency bands may be based on service characteristics. Certain services may be predefined or predesignated in association with certain frequencies or frequency bands used by a mobile network operator. In one example, voice communications in a mobile network can generally benefit from use of mid-band frequencies, such as in a range from 1 GHz to 6 GHz. Mid-band frequencies generally provide better coverage than high-band frequencies (above 6 GHZ), such as better penetration in buildings resulting in better call quality in indoor environments. Further, mid-band frequencies offer significantly higher speeds compared to low-band frequencies (below 1 GHz). The mid-band frequencies thus provide a good balance of clarity and reliability, including allowing for better voice compression and transmission. Accordingly, for a UE engaged in or initiating a voice call, a mid-band frequency band may be predesignated for the voice service to provide a best balance of performance for the UE.

Further, this mechanism can enable multi-country and regional RF band selection for 5G and other radio access technologies. Embodiments allow a mapping of different network services like “slice, voice, video, mission critical, first responder applications” to request a specific RF frequency priority. This may save or preserve critical RF resources for selected applications. For example, as noted, Band 14 is specifically designated for public safety agencies and other first responder users. The network can further put other lower priority applications or slices on non-Band 14 spectrum like n77, which has more capacity and will not easily get congested.

Different RF frequencies provide different service characteristics, and each network operator has access to specific low-, mid-, or high-band frequencies. Certain services work well in one RF frequency versus another. Also, a network operator may want to dedicate a specific RF frequency for a particular type of service to meet the performance service level agreement (SLA) guarantees. A SLA defines the level of service expected by subscribers from a mobile network operator. A typical SLA defines metrics by which the service is measured as well as remedied should agreed-upon service levels not be achieved. In conventional systems, there is no possibility to associate a frequency band with a particular service or function for communication between the UE and a base station.

In FIG. 2B the process 220 may be applied in a radio access network (RAN) including the base station 204a establishing communication with a user equipment UE 202. In this example, the RAN may extend across national boundaries or across a wide geographical region. As indicated in the drawing figure, the RAN implements a number of frequency bands including Band 77 for data service, Band 66 for video service, Band 14 for mission critical services and Band 12 for an on-demand application service. Other bands and other services may be defined and associated as well.

Initially, at step 220a, the base station, such as an eNodeB or eNB for an LTE network and a gNodeB or gNB for a 5G network, sends to the UE 202 an RF selection priority. This may correspond to the RFSP parameter, for example, and it may designate the UE 202 as having a primary preference for Band 14, corresponding to the mission critical services. In response, at step 220b, the UE 202 scans frequencies associated with Band 14 and camps on a Band 14 frequency. The UE 202 and the base station 204a may exchange data normally. The UE 202 may be involved in other services such as a file download, etc.

At step 220c, the UE subscribes for a particular service. In the example, the service is a first responder, mission critical, push-to-talk (PTT) service. A subscription request is conveyed over an uplink to the base station 204a and over a network to a first responder central portal 222. The first responder central portal 222 conveys information related to the request to a provisioning server 224. The provisioning server 224 controls information about what services and features are provisioned by the mobile network to the account associated with the UE 202. At step 220d, the provisioning server 224 establishes an RFSP value corresponding to first responder, mission critical, for the UE 202. This information is conveyed to a subscriber database such as a 5G network unified data repository (UDR) 226. Subsequently, the information about the RFSP value assigned to the UE 202 is conveyed from the UDR 226 to the 5G core network 228 for processing sessions involving the UE 202.

At step 220c, the 5G core network 228 sends to the base station 204a information about the newly assigned RFSP value. In this example, the new RFSP value indicates that, for the UE 202, Band 14 is the primary band for the user. Moreover, since in the example the radio access network may cover international boundaries or regional boundaries, step 220e includes specifying that the RFSP value applies to different public land mobile networks (identified by a PLMN number) in both local and international usages.

FIG. 2C depicts an illustrative embodiment of a method 230 for radio frequency band assignment in the system of FIG. 2A. The method 230 enables assignment of radio frequencies or frequency bands in a mobile network based on or in association with a service to be accessed or used by a user. The service may be accessed by users 230a, accessing a radio access network 230b. The radio access network 230b in turn can access a 5G access and mobility function (AMF) 230c and a 5G universal data repository (UDR) 230d. The mission critical service may be performed by a server such as mission critical service server 230e. The elements shown in FIG. 2C which perform the method 230 may communicate over any suitable network, including a 5G core network which implements the 5G AMF 230c and the 5G UDR 230d.

At step 232 a, a user of the users 230a accesses a selected service available over the network. In the example, the service is a mission critical service which may be used by first responders or other public service agencies. The service may be accessed, for example, by initiating an application on the UE of the user, initiating a communication associated with the ministry mission critical service, or receiving a communication associated with the mission critical service. A request is communicated from the UE of the user to the 5G AMF 230c of the 5G core network.

At step 232b, information about the user's subscription or provisioning is retrieved from the 5G UDR database 230d. The subscription information includes information about services available to the user, parameters defined for establishing the service and access of the user, and other information. In the example of FIG. 2C, an RFSP value of 1 is returned by the 5G UDR database 230d to the 5G AMF 230c. At step 232cC, the 5G AMF 230c communicates information defining the RFSP value to a base station or other network element of the radio access network 230b. The RFSP value may be sent, for example, in an initial context setup request message to the radio access network. At step 232d, a base station of the radio access network 230b communicates information about the RFSP value. In the example, the RFSP value is communicated in a radio resource control (RRC) connection release request message. The information is communicated on a downlink to the UE. The information indicates that Band 14 is designated to have the highest priority for the UE. Band 14 is defined to correspond to the mission critical service. The indication of highest priority means that the UE will prefer to access the radio access network 230b using one or more frequencies of Band 14. Further at step 232d, the radio access network 230b establishes other priority frequency bands for the UE, including Band 77, Band 66 and Band 12, in order of priority. In other examples, other frequency bands may be selected and prioritized.

At step 232c, the user attempts to connect to the network and camps on Band 14, as selected by the prioritization of frequency bands for the UE. At step 232f, the user seeks to access the mission critical service. This may be done by, for example, accessing an application on the UE related to the mission critical service established by mission critical service server 230c.

At step 232g, the user attempts to connect to another service, such as video streaming. At step 232h, a PDU session will be assigned 5QI having a value 8. In 5G, a PDU session provides end-to-end user plane connectivity between the UE and a specific data network, such as the mission critical service server 230e through the user plane function (UPF). A packet data unit (PDU) session supports one or more QoS flows. All packets belonging to a specific QoS flow have the same 5G quality of service indicator (5QI). A 5QI parameter having a value 8 corresponds to video with buffered streaming to the UE and corresponds to the video steaming service selected at step 232g.

At step 232i, the base station of the radio access network 230b signals the UE to perform an inter-frequency handoff (IFHO) to a different frequency band. Initially, step 232d, the UE was prioritized to Band 14. However, as noted Band 14 is designated for mission critical services. Since the user instead selected a non-mission critical service at step 232g, the network attempts to move the UE from the mission critical frequency Band 14 to a non-mission critical frequency band, Band 66. Subsequently, the UE may handover communication from Band 14 to Band 66, including remaining attached to the same base station.

### B. Infrastructure Core Selection

FIG. 2D is a block diagram illustrating an example, non-limiting embodiment of a system 236 functioning within the communication network of FIG. 1 in accordance with various aspects described herein. The system 236 includes a mobile access provider 204 which provides mobile communication services to user devices such as UE 202. The mobile access provider 204 is in data communication with two or more infrastructure core providers, including first infrastructure core provider 206a and second infrastructure core provider 206b. Further, the mobile access provider 204 is in data communication with the global orchestrator 210.

The mobile access provider 204 includes one or more aspects or functions of a 5G network. These include a unified data management (UDM), unified data repository (UDR) 236a including a authentication server function (AUSF). These functions are shown combined in a single functional unit but may be organized separately or in any suitable manner to provide the necessary functionality. The mobile access provider 204 further includes an access and mobility management function (AMF) 236b, a session management function (SMF) 236c, and a user plane function (UPF) 236d. The components are generally part of a 5G Core network and may be considered to have their functional features in the exemplary embodiment. The mobile access provider 204 further includes a gNodeB 236e which further operates conventionally to provide two-way radio access to user devices such as the UE 202.

In the illustrated embodiment, each of the infrastructure core providers, including first infrastructure core provider 206a and second infrastructure core provider 206b, includes a combined UDM and UDR 236a; a SMF 236c; a policy control function (PCF) 236f and a user plane function 236d. In the case of including first infrastructure core provider 206a and second infrastructure core provider 206b, the combined UDM and UDR 236a are in data communication with the global orchestrator 210; the SMF 236c is in data communication with the AMF 236b of the mobile access provider 204; the UPF 236d is in data communication with the gNodeB 236e of the mobile access provider 204.

Mobile networks may become more commoditized in the future, where it becomes difficult for mobile network operators to differentiate themselves and to extract revenue for providing the critical network infrastructure. Instead, the higher-level content or service providers may extract larger portions of revenue from the end users who treat mobile networks as interchangeable.

In the example embodiment of FIG. 2D, the user associated with UE 202 is attached to a specific mobile network or radio access network, mobile access provider 204. In effect, the user and UE 202 are locked into that network. In addition, though, the user and UE 202 have a choice of which core network to connect to, either first infrastructure core provider 206a and second infrastructure core provider 206b in this example.

In accordance with various aspects described herein, the different core networks may offer different features for the user and the UE 202. For example, the user may be highly cost conscious regarding the cost for mobile network service and, in this example, the core network associated with the first infrastructure core provider 206a is a relatively inexpensive pre-paid core network. In such a network, the user has access to relatively limited functions, but at a reduced cost. At times, though, the user or another user of the UE 202 may enjoy online gaming using the UE 202 and therefore require better latency and higher capacity from the core network. Such a user may choose core network associated with the second infrastructure core provider 206b. Thus, the mobile network operator may emphasize different aspects of a respective core network in order to market particular services to particular customers.

In embodiments, the first infrastructure core provider 206a and second infrastructure core provider 206b may register their respective core networks with the global orchestrator 210. Registration may include providing any suitable information about the respective core networks such as specific characteristics capabilities, features, costs, etc., of the core networks.

In the exemplary embodiment, the mobile access provider 204 features a lightweight core network, or a core network with a limited or reduced set of functions. In the example, the lightweight core network includes the combined UDM and UDR 236a, the AMF 236b, the SMF 236c and the UPF 236d. Other examples may include other core functions, either instead or in addition.

In some examples, the user operating the UE 202 may access the global orchestrator 210 in order to view what core network options are available for access. In an example, the user may access a web page through the UE 202 in order to view and select core network information. In other examples, the global orchestrator 210 may include an artificial intelligence function that predicts a suitable infrastructure core network based on the asserted or detected capabilities of the first infrastructure core provider 206a and second infrastructure core provider 206b and the detected requirements of the user. The recommendation or prediction may be made to the user and UE 202 by the global orchestrator 210 in any suitable manner. The user may, for example, review the recommendations and make a selection of a desired core network to attach to. The selection may be made, for example, by selecting a link displayed on a web page viewed by the user on the UE 202. In response to the user selection, the global orchestrator 210 operates to reprovision or reconfigure the user's connection to and access to the desired core network. The user and the UE 202 are then attached to the desired core network.

FIG. 2E is a block diagram illustrating an example, non-limiting embodiment of a global orchestrator 210 functioning within the system 200 of FIG. 2A in accordance with various aspects described herein. In the exemplary embodiment of FIG. 2E, the global orchestrator 210 includes a user portal 240, a registry server 242, a registry database 244 and an artificial intelligence/machine learning (AI/ML) engine 246. In other embodiments, the global orchestrator 210 may include alternative or additional components or functions.

The user portal 240 serves as a user interface or application programming interface (API) for access to the global orchestrator 210 by end users such as the UE 202 (FIG. 2D). The user portal 240 may be configured to receive inquiries and selections from end users and to provide responses in return to the users. Further, the user portal 240 may be operative to convey information based on the inquiries and selections to the other components of the global orchestrator 210. For example, a query, or information based on a query, may be forwarded from the user portal 240 to the AI/ML engine 246 and, in return, a response to the inquiry may be received at the user portal 240 from the AI/ML engine 246. Similarly, a query may be forwarded from the user portal 240 to the registry database 244 and, in return, a response to the inquiry may be received at the user portal 240 from the registry database 244. Such a query may relate to the capabilities of one or more available core networks.

The registry server 242 services as an interface or application programming interface (API) for access to the global orchestrator 210 by one or more infrastructure core providers such as the first infrastructure core provider 206a and second infrastructure core provider 206b (FIG. 2D). The infrastructure core providers may provide any suitable information about the capacity or capability of their core networks to the registry server 242. The registry server 242 in turn is in data communication with the registry database 244. Thus, the registry server 242 may collect and organize and otherwise process information received from the infrastructure core providers and store the information in the registry database 244 for access by users (through the user portal 240) or by the AI/ML engine 246.

The AI/ML engine 246 serves several function. In one aspect, the AI/ML engine 246 ingests input from multiple sources, including content from the registry database 244, user subscription information, and statistics from the mobile network, including but not limited to information about user behavior, user profile information, mobile cloud network service provider (MCNSP) performance, and MCIP network conditions. In a second aspect, if a user opts-in, the AI/ML engine 246 provides a recommendation on the service provider most appropriate for the user, based on a prediction of the user's desired balance of performance, cost, and capabilities or other factors.

The AI/ML engine 246 may receive from one or more mobile networks infrastructure statistics. Such statistics may relate to capabilities, capacities and other information for one or more mobile networks which may be accessed by users. For example, the statistics may be based on call daily record (CDR) information for network activity in the mobile network. In another example, the statistics may be based on key performance indicators (KPIs) that are monitored, recorded and tracked for the mobile networks. Further, the AI/ML engine 246 may access the information stored in the registry database 244 regarding capabilities of the infrastructure core providers. Still further, the AI/ML engine 246 may receive queries from users via the user portal 240. The queries may relate to available core networks, user requirements and preferences, and similar information. In response to all this received information, the AI/ML engine 246 may generate a prediction or recommendation for the user. The prediction or recommendation may define one or more core networks suitable for the user and the user's requirements. In response to the recommendation, the user may submit a selection and the global orchestrator 210 operates to connect the user to the selected infrastructure core network.

There are multiple options on how to implement the parameter provisioning to affect to which infrastructure core network the user gets attached. Examples include data network name (DNN), charging characteristics, slice identifier, or others.

Any suitable artificial intelligence tool or machine learning model, or combination of these, may be used to implement the AI/ML engine 246. In the case of a supervised model, any suitable training data may be used to train the model.

FIG. 2F is a block diagram illustrating an example, non-limiting embodiment of a portion of the system 236 shown in FIG. 2D in accordance with various aspects described herein. In particular, FIG. 2F illustrates access to the global orchestrator 210 by a user of a user device such as UE 202. FIG. 2F illustrates how an end user at UE 202 is able to reach the user portal 240 of the global orchestrator 210 in order to discover the available service providers and make a selection. In order to provide network connectivity to the user portal 240, the mobile network provider 204 operates a lightweight core to support a device attach and limited network connectivity to the user portal 240. The lightweight core in the example includes the AMF 236b, the SMF 236c and the UPF 236d.

In the illustrated example, the UE 202 accesses the radio access network associated with gNodeB 236e of the mobile access provider 204. As noted above, the mobile access provider 204 implements a lightweight 5G core with selected core functions including, in this example, the user plane function, UPF 236d. The UPF 236d operates to route data in the mobile access provider 204. In particular, the UPF 236d routes data between the UE 202 and the orchestrator user portal 240. In this manner, the user of the UE 202 can access the user portal 240 to communicate requirements and preferences for an infrastructure core network, to receive information about available core networks and to make a selection of a core network.

FIG. 2G depicts an illustrative embodiment of a method 250 for provisioning an infrastructure core network in the system of FIG. 2D. FIG. 2G shows an example call flow where multiple mobile core networks and service providers register themselves and an end user desires to connect to a service and attaches to the mobile network infrastructure provider to browse the user portal 240. In the example, the end user makes a selection and the end user's subscription gets updated. The end user subsequently re-attaches and gets directed to the selected service core. In some instances, it is possible that the user could also connect to multiple service cores concurrently using different data network names (DNNs). In particular, the method 250 may be used to collect information about available core networks, information about radio access networks and information about users, and to select a core network that is suitable for the requirements of a user at a UE 202. Similar to FIG. 2D, in the example of FIG. 2G, selection is made between two infrastructure cores including a network of the first infrastructure core provider 206a and second infrastructure core network 206b. In other examples, any number of cores may be evaluated and selected from.

At step 252a, the first infrastructure core network 206 A provides to the orchestra registry database 244 information about the network capabilities. Similarly, at step 252b, the second infrastructure core network 206b provides information about its capabilities to the orchestrator registry database 244. Any suitable information may be provided in reporting the capabilities of the core networks.

Separately, the user equipment UE 202 determines that it needs to select a service network. At step 252c, the UE 202 attaches to the base station or gNodeB 236e of the mobile access network provider. At step 252d, the UE 202 further attaches to the access provider AMF 236b.

At step 252e, the access provider AMF 236b determines subscription parameters for the UE 202. In the example, subscription information for the UE 202 or the account associated with the UE 202 is retrieved from the mobile access UDR 236a. For example, the subscription information may limit the type of core network that the UE 202 can select or attach to. Further, the subscription information may define charges or other costs that may be imposed on the UE 202 or the subscription account associated with the UE 202. At step 252f, the UE 202 attaches to the access provider core. In the example, the UE 202 attaches to the UPF 236d in the lightweight core included in the mobile access provider network.

At step 252g, the user associated with the UE 202 may browse and select among available infrastructure networks. In this example, the available infrastructure networks are the network of the first infrastructure core provider 206a and the second infrastructure core network 206b. For step 252g, the UE 202 accesses the user portal 240 of the global orchestrator 210. Any suitable information may be presented by the user portal 240 to the user of the UE 202. In one example, a web page is provided on a web browser operating on the UE 202. The web page may include any suitable information about the capabilities and facilities of the available infrastructure networks. The user of the UE 202 may take any suitable steps to select a preferred infrastructure network, including making a selection using the web browser.

In examples, the information presented to the UE 202 may include selected information provided by an AI/ML process. The AI/ML process may operate to predict a best option among the available infrastructure core networks to satisfy needs or preferences of the user of the UE 202. In some embodiments, the AI/ML process may recommend more than one available infrastructure core network and enable the user of the UE 202 to select one of the recommended networks.

Add step 252h, a selection of one of the available infrastructure core networks is made. In this example, the second infrastructure core network 206b is selected by the user of the UE 202. At step 252i, provisioning information for the second infrastructure core network 206b is provided from the user portal 240 to the UDR 236a of the network of the mobile access provider 204. Any suitable provisioning information may be provided, such as network addresses for use by the UE 202 and information about core network capabilities and settings.

At step 252j, a process of reattaching the UE 202 to the network components begins. At step 252j, the UE 202 reattaches to the gNodeB 236e of the network of the mobile access provider 204. Further, at step 252k, the UE 202 attaches to the AMF 236b of the mobile access provider. At step 252i, the UE 202 and the AMF 236b verify the subscription information for the second infrastructure core network 206b. Verification may be performed using the provisioning information stored in the UDR 236a. At step 252m, the AMF 236b attaches to the second infrastructure core 206b, providing a network link between the UE 202, through the mobile access provider 204, to the second infrastructure core 206b. At step 252n, service data flow begins and the UE 202 has access to functional features of the second infrastructure core 206b.

Wireless, wireline and satellite networks require prohibitive cost to build and expand. As these networks become more connected these costs continue to rise. Further, an operator of such a network can continue to build multiple levels of resiliency or capacity. However, in both scenarios, the operator can be over- or under-subscribed, meaning in case of a sudden surge of new subscribers the operator and the network are not able to meet the demand. Generally, additional network capacity cannot be added dynamically. On the converse the operator may have multiple levels of redundancy in a region but if the whole region fails, the operator may still experience an outage for subscribers.

Conventionally, network capacity is planned in a static fashion. This means that a network operator may have built out the network to support 100 Gbps bandwidth from the network but may still experience demand spikes. In an example, there may be a need to add bandwidth to the existing network for a short span of time due to particular events that need this bandwidth. Subsequently, the network operator no longer needs this additional capacity in the network. Conventional models are static and the operator needs to predict such demand spikes and have additional bandwidth preconfigured. Such additional capacity cannot be dynamically added as the demand increases or decreases.

Public safety networks often require a relatively high level of resiliency. Conventionally, public service agencies or operators of such networks purchase wireless and wireline services from multiple network operators and have multiple layers of backups available. However, it is very expensive for the public safety agencies to have multiple lines of service in this manner.

There are often use cases around low latency like connected vehicles or smart factories, etc., which require certain services with a predefined service level agreement (SLA). Conventionally, the network operator must over-engineer the network to meet these demands. There may be no way to dynamically load-balance the network to offload traffic to a backup network to provide the resources for certain SLA-based use cases like low latency.

When a failure occurs at a location in a network, the network operator may need to move traffic to alternate sites. This may require manual intervention by network engineers. The network operator may have no capability to automatically detect such a failure and provide a network backup on demand.

As wireless and wireline networks get connected, increasingly there is a demand for a mechanism that can provide backup for wireless networks on wireline networks and vice-versa. In the event of a network failure, traffic would desirably be routed from the network with the failure to an intact network, independent of technology. Conventionally, no such capability exists.

Network operators and providers of communication services offer different services to customers. In some cases, these services need their own core infrastructure. There is conventionally no way for the operator today to share or request for backup or a fallback option to a service core than can support a particular service in case of demand increase or service outage on primary network.

Increasingly Non-Terrestrial-Networks (NTN) such as satellite networks are being integrated with terrestrial wireless infrastructure. Conventionally, there is no way for network operators to request for fallback to a wireless or wireline infrastructure when a portion of a satellite network fails or when there is gap in satellite coverage. The opposite problem is true as well. There is conventionally no mechanism for wireless or wireline infrastructure providers to request fallback to satellite communication when a portion of the terrestrial network fails or there are capacity concerns.

Mobile network operators attempt to differentiate their services and maintain subscribers through claims of being the fastest or most reliable networks, bringing new technologies (such as 5G) to market, offering discounts, or signing customers to long-term contracts. While these may be effective for the short-term, end users increasingly see little differentiation between mobile network operators. There is currently a concept of a Mobile Virtual Network Operator (MVNO), where an entity may provide mobile network services to end users by contracting with a Mobile Service Provider who owns and operates a physical network infrastructure. While the MVNO model does create a distinction between the Mobile Network Infrastructure Provider and Mobile Core and Service Provider, it does not provide to the end user a dynamic capability to select and switch between radio frequencies, infrastructure core providers or service core providers in real-time based on end user needs.

In embodiments, the system 200 of FIG. 2A may tie a RF band selection to a service. When a subscriber purchases a specific service from a network operators, such as for example mission critical network services, a specific RFSP value may be assigned to the subscriber. When the subscriber seeks to access that service, the user camps on a specific RF frequency. This is illustrated, for example in FIG. 2A, FIG. 2B and FIG. 2C.

Further, FIG. 2D, FIG. 2E, FIG. 2F and FIG. 2G illustrate examples of a process of infrastructure core selection. In the example of FIG. 2A, the mobile access provider 204 supplies the direct interface to an end user and as well as various key network capabilities. These may include radio spectrum and coverage; user subscription information, including authentication credentials; user registration; user mobility management; and a subset of core functionality.

In the illustrated examples, the mobile access provider 204 also supplies the connectivity and interfaces to the global orchestrator 210, as illustrated in FIG. 2D. The infrastructure core providers associated with the infrastructure core networks may establish a relationship with the mobile access provider 204 in advance though an onboarding process. The mobile access provider 204 may define a catalog of capabilities that the infrastructure core providers may claim to provide including, but not limited to connectivity to the public internet; connectivity to a private network; low-latency networking; connectivity to specific content; vehicle to everything (V2X) services; value-added security capabilities; voice and video services; and others.

The infrastructure core providers may announce their ability to provide a specific set of services through a registration process to the global orchestrator 210 of the mobile access provider 204. The orchestrator service provided by the global orchestrator provides the interface to network function of the mobile access provider 204. The network functions contain the user's subscription information in order to supply updates as needed to allow the user to connect to a desired service core provider of the service core providers 208. Once the end user has made a selection, the mobile access provider 204 provides the network connectivity necessary for the user to attach to and exchange data with the selected service provider core. This network connectivity includes both control plane and user plane.

### C. Service Core Selection

FIG. 2H depicts an illustrative embodiment of a backup and disaster recovery system 260 in accordance with various aspects described herein. Current and future mobile communications employ a variety of access networks. These may be provided by multiple network operators or by a single network infrastructure provider 266. These may include radio access network, satellite networks and wireline networks. As shown in FIG. 2A, the mobile access networks communicate with an infrastructure core network 206 and in turn may communicate with networks of one or more service core providers 208. The example of FIG. 2H includes a voice service core 208a, a messaging service core 208b, a mission critical service core 208c, a low latency service core 208d, and others as indicated at service core network 208n.

These may be grouped together under the heading of home network services. Customers have regular access to these services, based on a subscription, contract or other arrangement. As part of their service agreements, customers expect a very high degree of availability of a given service. This may include full redundancy, or in some cases multiple redundancies. However, building out the original network is difficult and expensive. Building out the redundant networks adds substantially to the cost of network infrastructure. Given modern levels of network reliability, a redundant network or network portion may only see very rare usage.

Accordingly, the backup and disaster recovery system 260 includes an orchestrator service 264. In embodiments, the orchestrator service 264 provides a network operator such as network infrastructure provider 262 the capability to register to a backup and disaster recovery service provider. For example, the backup and disaster recovery service provider may provide backup services to a variety of network operators such as multiple operators of mobile networks or operators of private networks.

In the example, the backup and disaster recovery service provider operates a backup and disaster recovery core 266. The backup and disaster recovery core 266 includes a voice service core, a messaging service core, a mission critical service core, a low latency service core, on through other service cores indicated by the letter “N.” The orchestration service 262 may be used to route communications from an origin network to a backup network provided by the backup and disaster recovery core 266. In the manner, the backup and disaster recovery core 266 provides backup and disaster recovery as a service to any number of network operators.

In an example, a first mobile network operator has built out its proprietary voice core such as voice core 208a. The first mobile network operator provides service to its subscribers using voice core 208a. The first mobile network operator, however, desires to add a degree of resiliency to its voice network but would prefer not to invest in the infrastructure equipment and installation to build a redundant network. Instead, the first mobile network operator registers with the orchestrator service 264 operated by the backup and disaster recovery service provider. The two operators may have a service agreement providing that, in the event of an outage with the first mobile network operator's voice service, the traffic may be switched to the backup and disaster recovery core 266 for voice network processing in the back up voice service core. The switch over can be essentially invisible to subscribers of the first mobile network operator's voice services.

In a first operation, the exemplary embodiments give the first mobile network operator the ability to fall back to an alternate service core when the primary service core is unavailable. In the event of a network outage or service degradation, traffic may be routed instead through a backup service core provided by the backup and disaster recovery core 266.

Further, in a second operation, the backup and disaster recovery core 266 provides rapid expansion of network capacity. Networks sometimes experience short term spikes in traffic levels due to a particular event such as the Olympics, a concert at a particular venue, and others. The operating, in-place network may be adequate for normal operation by the sudden short term spike in traffic levels may require supplementation to handle. In that case, a portion of the traffic may be routed to the alternate service core formed by the backup and disaster recovery core 266. The mobile network operator facing the sudden increase in traffic may contrast with the backup and disaster recovery core service provider to provide access through the orchestrator service 262.

In a further example, a single network operator may operate multiple communication networks, including a wireless network, a wireline network and a satellite network. The network operator may provide redundancy to users of one network on another network under a service agreement. In an example, a customer has a service agreement for wireless services. In addition, the subscription agreement provides that, in the event of a network outage, the customer's traffic will be switched to one of the other networks, either the satellite network of the wireline network. In effect, the subscription includes a backup service offered by the network operator using the operator's alternative networks. Still further, the backup service may be limited to or written to include particular services, such as voice service only, or mission critical services only, or voice and messaging services only. In the last example, in the event of a network failure in a wireless network, voice and messaging services may be switched by the orchestrator service 262 to an alternative network, the satellite network of the wireline network in this example. Other services of the subscriber will not be switched to the backup network, based on the terms of the subscription agreement.

The backup and disaster recovery core service provider registers what services are provided in the orchestrator service 262. Information about those available services is provided to the infrastructure core 206 and the radio access network of the mobile access provider 204 of the network infrastructure provider 262. Information advertising the backup and disaster recovery service may be broadcast to a variety of network operators or may be provided in response to a direct query from the network infrastructure provider 262.

In accordance with some embodiments, end users including consumers can subscribe for backup and disaster recovery services to make sure their services are more resilient. In an example public safety agencies might elect to subscribe to the backup and disaster recovery service.

In another example, wireline, wireless, or satellite network infrastructure providers (WWSNIP) can subscribe for backup and disaster recovery services to take benefits of enhanced resiliency, backup services, land and balancing services to augment their existing network infrastructure and services to dynamically scale up and down based on capacity needs and condition of the network. The WWSNIP supplies home network core and services to the end user and various key network capabilities, including radio spectrum and coverage, user subscription information, including authentication credentials, user registration, user mobility management, a subset of core functionality, and access to home network services.

The backup and disaster recovery services provider may establish a relationship with the WWSNIP in advance through an onboarding process. The WWSNIP defines a catalog of capabilities that the backup and disaster recovery services provider may claim to provide when there is a disaster or backup and load balancing capabilities to scale the network demand up and down dynamically. These capabilities may include, for example, voice service and voice core, messaging service and messaging core, mission critical service and mission critical core, low latency service and core, regulatory service and core, various miscellaneous services and core, and broadband or fiber services and core. The backup and disaster recovery services provider may announce an ability to provide a specific set of services or core networks through a registration process to the WWSNIP.

In the example, the orchestrator service 262 also provides the interface to the WWSNIP's network function which contain the user's subscription in order to supply updates as needed to allow the user or network operator to connect to the desired backup and disaster recovery provider. As an example, the backup and disaster recovery services provider may support use cases for backup and disaster recovery in case of a service or a service core not being available.

FIG. 2I depicts an illustrative embodiment of a load balancing system 268 in accordance with various aspects described herein. In the event of an overloaded network segment, the backup and disaster recovery core 266 may be used to manage the traffic load or balance the load. A network infrastructure operator 266 may shift traffic to facilities of the backup and disaster recovery core 266 during a limited time period to provide virtual added network capacity. In the exemplary load balancing scenario, 50 percent of infrastructure core is load balanced by shifting 50 percent of traffic from the infrastructure core 206 to the backup and disaster recovery core 266. Also, in the example, only the messaging service and the mission critical core are load balanced. Thus, the backup and disaster recovery service provider may support use cases for load balancing in case of core load balancing or service-specific load balancing. In the example, messaging service load balancing occurs due to sudden surge in demand in the primary network.

FIG. 2J is a block diagram illustrating an example, non-limiting embodiment of a portion of the system 236 shown in FIG. 2D in accordance with various aspects described herein. In particular, FIG. 2J illustrates access to the user portal 240 of the global orchestrator 210 by a user of a user device such as UE 202. FIG. 2J illustrates how an end user at UE 202 is able to reach the user portal 240 of the global orchestrator 210 in order to discover the available backup and disaster recovery service providers and make a selection of a service provider. In order to provide network connectivity to the user portal 240, the mobile network provider 204 operates a lightweight core to support a device attach and limited network connectivity to the user portal 240. The lightweight core in the example includes the AMF 236b, the SMF 236c and the UPF 236d.

In the illustrated example, the UE 202 accesses the radio access network associated with gNodeB 236e or a wireline access gateway function (WAGF) of the mobile access provider 204, or accesses through the public internet such as through a Wi-Fi connection to a router. As noted above, the mobile access provider 204 implements a lightweight 5G core with selected core functions including, in this example, the user plane function, UPF 236d. The UPF 236d operates to route data in the mobile access provider 204. In particular, the UPF 236d routes data between the UE 202 and the orchestrator user portal 240.

In this manner, the user of the UE 202 can access the user portal 240 to communicate requirements and preferences for an infrastructure core network, to receive information about available core networks and to make a selection of a backup and disaster recovery network. The orchestrator service may provide access to a variety of backup and disaster recovery service providers, each offering particular services at particular prices. The global orchestrator, through user portal 240, provides provisioning information about a selected backup and disaster recovery service provider to the UDR 236a.

In an alternative embodiment, a network operator such as a wireless, wireline or satellite infrastructure provider may also access the orchestrator service 262 through the user portal 240 of the global orchestrater. The user portal 240 may provide a suitable user interface or application programming interface to manage selection of a backup and disaster recovery service provider. Moreover, the services that may be provisioned include a disaster recovery core and a service core. This may enable service recovery as well as load balancing for the network operator.

FIG. 2K depicts an illustrative embodiment of a method 270 for provisioning a backup and disaster recovery network in the system of FIG. 2H. FIG. 2K illustrates an example call flow where multiple backup and disaster recovery core and service providers (BDRCSP) register themselves. In the example, a first BDRCSP core 266a and a second BDRCSP core 266b register with the orchestrator service. Further, an end user/WWSNIP 270a desires to connect to a service or core and attaches to the network infrastructure provider or public internet access point or gNodeB 270b to browse the user portal 240. The end user or network provider makes a selection and their subscription information gets updated. Subsequently, the end user re-attaches and gets directed to the selected Backup and Disaster Recovery Core or Service. In some embodiments, it is possible that the user could also connect to multiple Service Cores concurrently using different DNNs.

In the method 270, at step 272a, the first BDRCSP core 266a registers with the orchestrator registry database 244. At step 272b, the second BDRCSP core 266b also registers with the orchestrator registry database 244. Registration may include providing information about capabilities and requirements of the BDRCSP cores, as well as any other suitable information.

At step 272c, a WSNIP device 270a needs to select a core network or a service network for backup and disaster recovery services. At step 272d, the device 270a attaches to the network, such as attaching to a gNodeB 270b of a mobile operator network or an access gateway to the public internet. At step 272e, the gNodeB 270e of the mobile operator network attaches to an AMF 270c of the WWNSIP. At step 272f, the AMF 270c of the WWSNIP verifies the subscription information for the device 270a. At step 272 G, if the subscription information verifies, the AMF 270c attaches to the WWSIP core network 270c.

Add step 270h, a user of the device 270a may browse information about available BDRCSP cores using the user portal 240 of the orchestrator service. The user of the device 270a may select a core network or serving network for backup and disaster recovery services. At step 272i, selection of the second BDRCSP 266b is made by the user of the device 270a. At step 272k, provisioning information for the second BDRCSP core 266b is provided from the user portal 240 to the BDRCSP core UDR 270e.

At step 272l, the device 270a reattaches to the gNodeB 270b or other network connection. At step 272m, the gNodeB 270b or other network connection attaches to the AMF 270c. Further, at step 272n, the AMF 270c verifies subscription information with the second BDRCSP core UDR270c. At step 2720, based on the verified subscription information, the AMF 270c attaches to the second BDRCSP 266b. At step 272p, service data flow begins.

Embodiments allow flow-based charging capabilities where, based on the type of backup and disaster recovery core and service providers used and the type of capability used (such as backup and restore, load balancing, capacity management etc.), the BDRCSP may define charging based on a specific flow usage. For example, as shown in FIG. 2I, a first charging flow extends between the network infrastructure provider 262 and the voice service core 208a and the messaging service core 208b. A second charging flow extends between the network infrastructure provider 262 and the backup and disaster recovery core and service provider 266. Charging may be based on the respective percentages of capacity used in each case.

Referring again to FIG. 2A, the selection engine 214 collects information about network facilities and operation and user requirements. That information may include information about what the infrastructure networks assert they can offer, what types of services or what levels of services, and at what cost. Further, that information may include information about user requirements, such as a type of service the user wants to access. One example is mission critical services. Further, the selection engine 214 may collect network infrastructure statistics. This may be information about how the access network is actually behaving. This may be based on key performance indicators or other information. This may be based on user behavior and experience. The selection engine 214 has information about traffic flowing in each of the infrastructure core networks including information about latency and throughput and packet loss, for example. The selection engine 214 may implement a feedback loop that allows it to find the best match in terms of what is the intent of the user versus what is actually happening in the access network and on each of the core infrastructure providers. The selection engine 216 operate similarly on information about the core infrastructure providers and the service core providers.

The selection engine 212 operates to control selection of radio frequencies for the radio access network. The selection engine 212 operates as a recommendation engine. It operates to collect user information and evaluate performance. For example, if a user and UE 202 is accessing mission critical services, the selection engine 212 may initially that Band 14 is the optimal band for the UE 202, where optimality is based on factors determined by the selection engine 212. However, the selection engine 212 is continuously collecting user information and network information and performance information. Based on this collected information, the selection engine is learning continuously. Based on this learning, the selection engine may determine that Band 14 is not the optimal band for the user and UE 202. The selection engine 212 can dynamically adapt to the user's service needs and provide the right set of radio frequency selection for the user as well as the right set of quality, priority and preemption capabilities for that user. Thus, the selection engine 212 may recommend or force a change for the UE from the current frequency band to a preferred frequency band, or from a current QoS level to a preferred QoS level. This may include overriding the dedication of Band 14 for mission critical services. Further, the process is dynamic so that if an outage is detected in the network (based on KPIs for example), the selection engine 212 may recommend a switch to other network facilities.

While for purposes of simplicity of explanation, the respective processes are shown and described as a series of steps or acts in several drawing figures, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

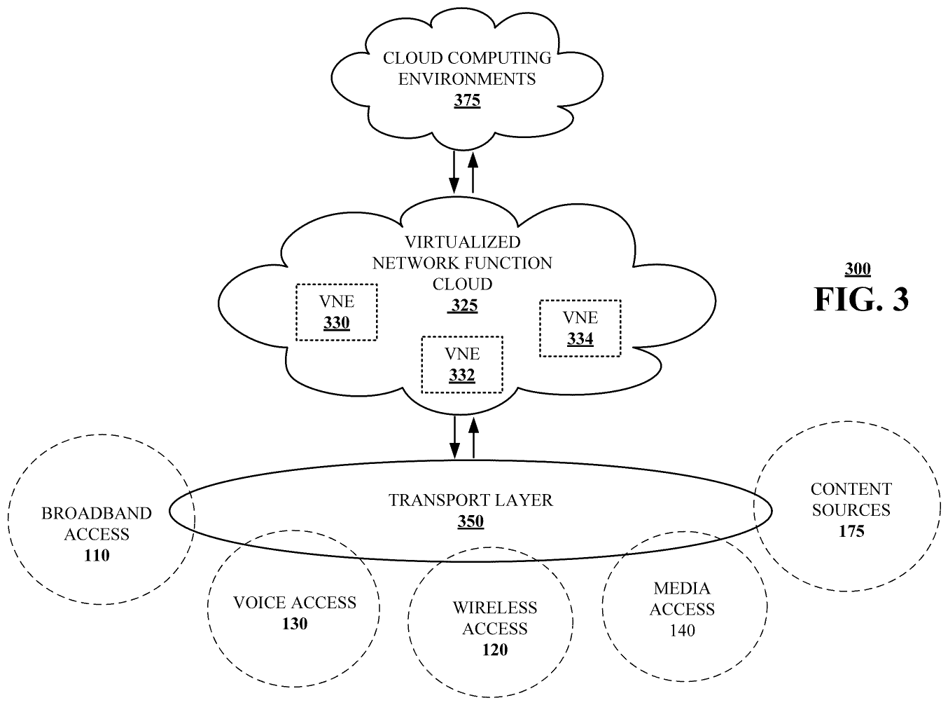

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, method 230, method 250, method 270 presented in FIGS. 1, 2A, 2B, 2C, 2G, 2K and 3. For example, virtualized communication network 300 can facilitate in whole or in part selecting a frequency band for user equipment in a mobile network based on a service to be accessed by the user equipment, selecting an infrastructure core network from a plurality of available infrastructure core networks, selecting a service core network from among a plurality of available service core networks.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers—each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

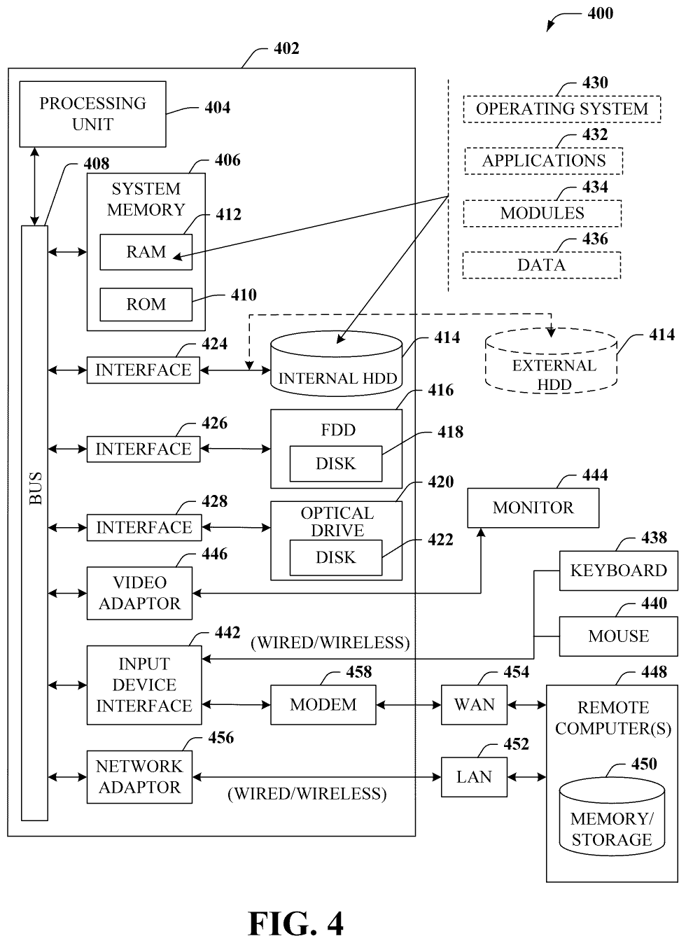

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part selecting a frequency band for user equipment in a mobile network based on a service to be accessed by the user equipment, selecting an infrastructure core network from a plurality of available infrastructure core networks, selecting a service core network from among a plurality of available service core networks.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are examples and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

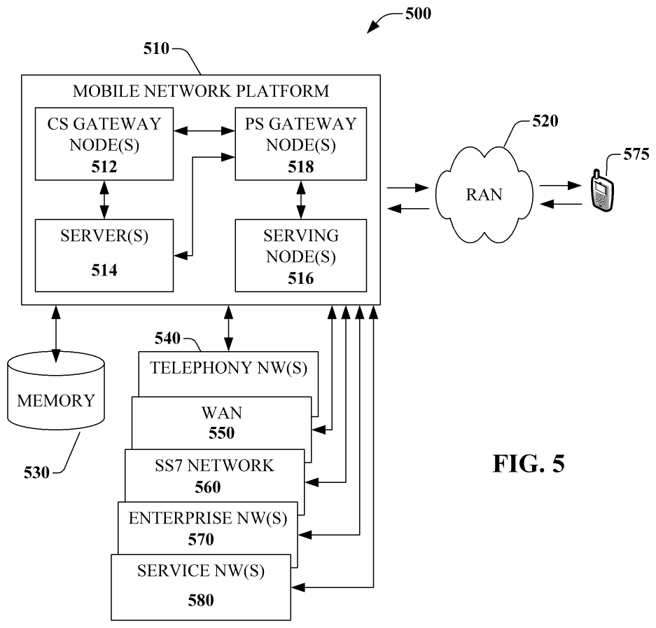

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part selecting a frequency band for user equipment such as radiotelephone 575 in a mobile network such as RAN 520 based on a service to be accessed by the user equipment, selecting an infrastructure core network from a plurality of available infrastructure core networks, selecting a service core network from among a plurality of available service core networks. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technologies utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

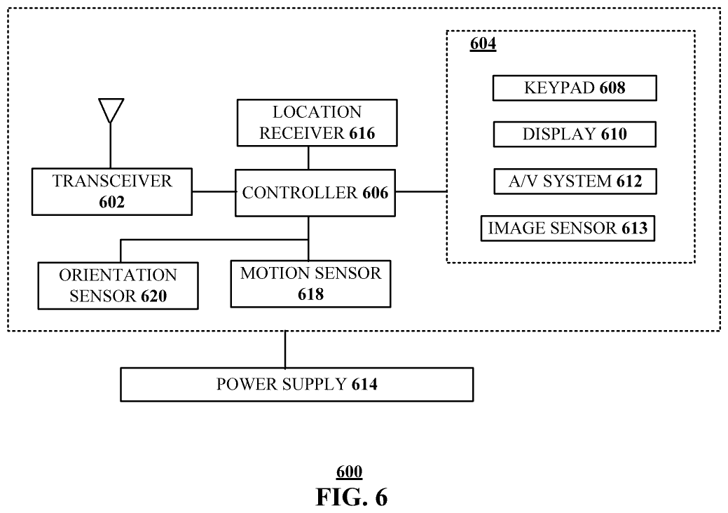

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part selecting a frequency band for user equipment such as the communication device 600 in a mobile network based on a service to be accessed by the user equipment, selecting an infrastructure core network from a plurality of available infrastructure core networks, selecting a service core network from among a plurality of available service core networks.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VOIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human car) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and cast, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
attaching a user equipment (UE) to a radio access network at an access frequency;
receiving, from the UE, a request to access a selected service through the radio access network; and
assigning the UE to a selected frequency band for accessing the service, wherein the selected frequency band for accessing the service is selected based on the service.

2. The device of claim 1, wherein the operations further comprise:
collecting network usage information for the UE and other user devices on the radio access network, forming first collected information;
collecting UE network access information for the UE accessing the service on the radio access network, forming second collected information;
providing the first collected information and the second collected information to an artificial intelligence or machine learning process;
determining from the artificial intelligence or machine learning process a recommended frequency band for the UE, the recommended frequency band being predicted by the artificial intelligence or machine learning process to provide improved quality of experience to the UE for accessing the service on the radio access network; and
reassigning the UE to the recommended frequency band.

3. The device of claim 1, wherein the receiving the request to access the selected service further comprises:
receiving a request to access mission critical services through the radio access network.

4. The device of claim 3, wherein the assigning the UE to a selected frequency band comprises:
assigning the UE to a frequency band designated for mission critical communications.

5. The device of claim 1, wherein the assigning the UE to a selected frequency band comprise:
assigning the UE to a preferred frequency band for access to the service.

6. The device of claim 5, wherein the operations further comprise:
communicating a radio access technology (RAT) frequency selection priority (RFSP) index value to the UE, the RFSP index value corresponding to the preferred frequency band.

7. The device of claim 1, wherein the receiving the request to access the selected service further comprises:
receiving, from the UE, a request to access a web site associated with the selected service.

8. The device of claim 1, wherein the operations further comprise:
reattaching the UE to the radio access network at the selected frequency band;
subsequently, determining that the UE is no longer accessing the service;
reassigning the UE to a different frequency band not associated with the service; and
instructing the UE to perform an inter-frequency handover to the different frequency band.

9. The device of claim 1, wherein the operations further comprise:
associating a radio access technology (RAT) frequency selection priority (RFSP) index value with the service for all UEs in the radio access network.

10. A non-transitory machine-readable medium, comprising executable instructions that, when executed by a processing system including a processor, facilitate performance of operations, the operations comprising:
attaching a user equipment (UE) to a radio access network;
receiving capability information about a plurality of available infrastructure core networks accessible to the radio access network;
selecting, based on the capability information, a selected infrastructure network;
determining provisioning information for the selected infrastructure network;
reattaching the UE to the radio access network; and
attaching the UE to the selected infrastructure network based on the provisioning information for the selected infrastructure network.

11. The non-transitory machine-readable medium of claim 10, wherein the selecting the selected infrastructure network comprises:
providing, to an artificial intelligence or machine learning process, the capability information;
providing, to the artificial intelligence or machine learning process, information about UE requirements of the UE;
providing, to the artificial intelligence or machine learning process, network usage information for the UE and other user devices on the radio access network;
receiving, from the artificial intelligence or machine learning process, a recommended infrastructure network, the recommended infrastructure network being predicted by the artificial intelligence or machine learning process to satisfy the UE requirements based on the network usage information; and
selecting the recommended infrastructure network as the selected infrastructure network.

12. The non-transitory machine-readable medium of claim 11, wherein the selecting the selected infrastructure network comprises:
receiving a user selection from the UE at a user portal of an orchestrator, the orchestrator implementing the artificial intelligence or machine learning process.

13. The non-transitory machine-readable medium of claim 10, wherein the operations further comprise:
verifying subscription information for the UE, the subscription information defining authorization for the UE to access plurality of available infrastructure core networks.

14. The non-transitory machine-readable medium of claim 13, wherein the verifying subscription information for the UE comprises:
generating a query at an access and mobility function (AMF) of the radio access network;
conveying the query from the AMF to a unified data repository (UDR) of the radio access network; and
receiving a response to the query at the AMF from the UDR, the response including the subscription information for the UE.

15. The non-transitory machine-readable medium of claim 10, wherein the receiving capability information about a plurality of available infrastructure core networks comprises:
receiving information about Internet connectivity for a respective infrastructure core network;
receiving information about connectivity to a private network for the respective infrastructure core network;
receiving information about connectivity to mission critical services for the respective infrastructure core network;
receiving information about low latency networking for the respective infrastructure core network; or
receiving information about voice and video services for the respective infrastructure core network.

16. A method, comprising:
attaching, by a processing system including a processor, a user equipment (UE) to a radio access network;
receiving, by the processing system, capability information about a plurality of available service core networks accessible to the radio access network through an infrastructure core network, the plurality of available service core networks providing network services of interest;
selecting, by the processing system, a selected service network, wherein the selecting is based on the capability information;
attaching, by the processing system, the UE to the selected service network, wherein the selecting is based on the capability information for the selected service network; and
initiating, by the processing system, communication between the UE and the selected service network, including providing network services from the selected service network to the UE.

17. The method of claim 16, further comprising:
determining, by the processing system, backup requirements for a service network associated with the infrastructure core network; and
selecting, by the processing system, the selected service network, wherein the selecting is based on an ability of the selected service network to satisfy the backup requirements for a service network.

18. The method of claim 16, further comprising:
selecting, by the processing system, a plurality of selected service networks, wherein a first selected service network of the plurality of selected service networks is provided by a first network operator and provides a first service for the UE and wherein a second selected service network of the plurality of selected service networks is provided by a second network operator and provides a second service for the UE.

19. The method of claim 16, comprising:
determining, by the processing system, a network failure of a portion of a service network associated with the infrastructure core network; and
reassigning, by the processing system, access to the portion of the service network to the selected service network for disaster recovery by the selected service network.

20. The method of claim 19, comprising:
determining, by the processing system, one or more services performed by the portion of the service network and affected by the network failure of the portion of the service network; and
reassigning, by the processing system, access to the one or more services to the selected service network for disaster recovery of the one or more services by the selected service network.
